(19) United States
(12) Patent Application Publication
(10) Pub. No.: US 2006/0161914 A1
(43) Pub. Date: Jul. 20, 2006

(54) Systems and methods to modify application installations

(75) Inventors: Shane Adamek Morrison, Seattle, WA (US); Joseph Anthony East, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/036,118

(22) Filed: Jan. 14, 2005

(51) Int. Cl. G06F 9/445

(52) U.S. Cl. 717/174

(57) ABSTRACT

Systems and methods for modifying application installations are described. In one aspect, a generic installation modifier package is created. The generic installation modifier package specifies differences between a target modified application installation and an already installed baseline application installation. The generic installation modifier package does not include information that is extraneous to modification of the already installed baseline application installation unless the information is designated as transparent to an installer application. The generic installation modifier package is communicated to a patch engine for subsequent modification of the baseline installation.

### TECHNICAL FIELD

This disclosure relates application installation and installation modification.

### BACKGROUND

A component installation application (installer) such as a WINDOWS Installer provides product deployment and component management. For instance, an installer takes an installation package, for example, an MSI file, as input to install one or more products or applications into an original or baseline installation. The installer is typically used to modify (patch) the baseline installation according to predefined settings. To make changes or modifications to an original or baseline application (e.g., product) installation, a new, modifying installation package is created. Conventional modifying installation packages are typically not portable across different operating environments. This is because a modifying installation package is typically compatible only with the data format required by the particular operating environment and/or installer that is going to unpack the modifying installation package to perform the baseline installation modification(s). As a result, several different modifying installation packages must typically be generated to modify any particular baseline installation deployed across different operating environments (e.g., different operating systems, systems that use different types of installer applications, etc.).

Additionally, a conventional modifying installation package typically represents an entire re-installation package for a baseline installation targeted for modification. This is because the modifying installation package generally includes all aspects (e.g., information, components (files), data resources, etc.) associated with the baseline installation targeted for modification, plus and/or minus those aspects that are being modified with respect to the baseline installation. As a result, existing modifying installation packages typically include a lot of extraneous material that will not be directly utilized to actually modify a baseline application installation.

When a complex build environment is targeted for modification, the need to specify/include extraneous material into a modifying installation package can be problematic. One reason for this is because the extraneous material may represent a tremendous amount of information, possibly including specification/inclusion of many-thousands of extraneous files and/or data resources. Representing such extraneous information is typically time consuming, requiring a substantial amount of administrative supervision, as well as computer processing, and resource utilization.

### SUMMARY

Systems and methods for modifying application installations are described. In one aspect, a generic installation modifier package is created. The generic installation modifier package specifies differences between a target modified application installation and an already installed baseline application installation. The generic installation modifier package does not include information that is extraneous to modification of the already installed baseline application installation unless the information is designated as transparent to an installer application. The generic installation modifier package is communicated to a patch engine for subsequent modification of the baseline installation.

### BRIEF DESCRIPTION OF THE DRAWINGS

In the Figures, the left-most digit of a component reference number identifies the particular figure in which the component first appears.

FIG. 1 illustrates an exemplary system for modifying application installations.

FIG. 2 shows an exemplary procedure for modifying application installations.

FIG. 3 shows an example of a suitable computing environment in which systems and methods for modifying application installations may be fully or partially implemented.

### DETAILED DESCRIPTION

Overview

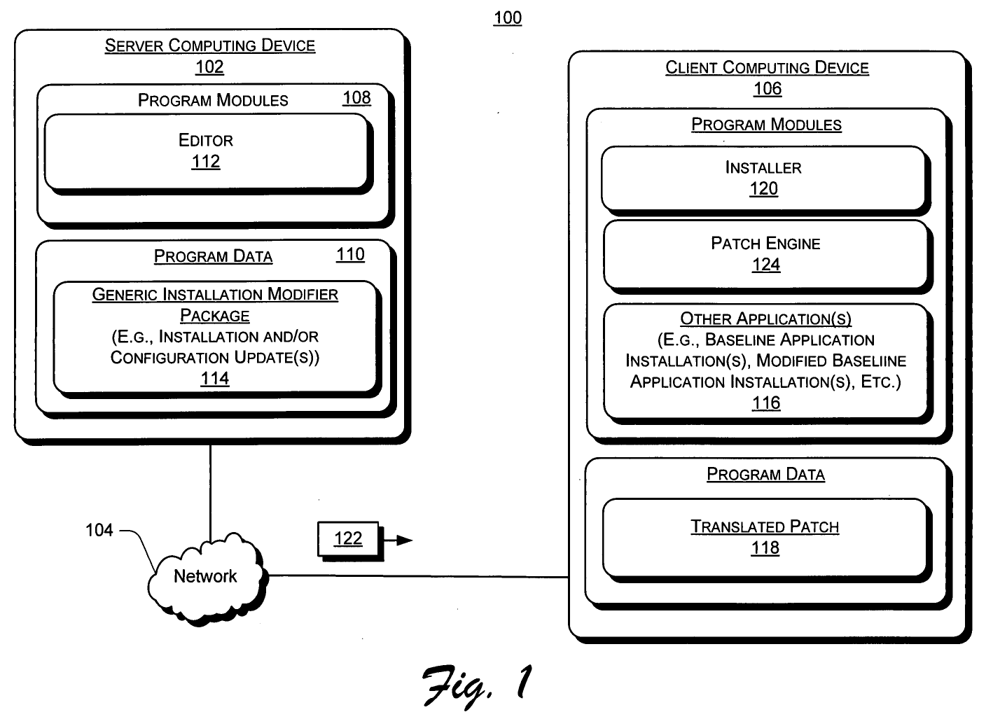

The systems and methods for modifying existing application or product installations as described below with respect to FIGS. 1 through 3, generate and implement a generic installation package to modify an original or baseline application installation. A generic installation package is generic because it is portable across different operating environments and installer applications. That is, the data format of the generic installation package is not hardwired to any target installation application or computing environment. This is in contrast to conventional installation packages, which are typically hardwired to a proprietary data format compatible with a particular installer application.

Additionally, a generic installation package is relatively lightweight as compared to a conventional modifying installation package. This is because the generic installation package does not specify extraneous information, components (files), data resources, and/or so on, of a baseline installation that is targeted for modification. Rather, the generic installation package specifies/includes only information and material representing the difference (modification) between a baseline installation targeted for modification, and the modified baseline installation.

These and other aspects of the systems and methods for bi-directional temporal error concealment are now described in greater detail.

An Exemplary System

Although not required, the systems and methods for modifying application installations are described in the general context of computer-executable instructions (program modules) being executed by a computing device such as a personal computer. Program modules generally include routines, programs, objects, components, data structures, etc., that perform particular tasks or implement particular abstract data types. While the systems and methods are described in the foregoing context, acts and operations described hereinafter may also be implemented in hardware.

FIG. 1 shows an exemplary system 100 for modifying application installations. In this implementation, system 100 includes server computing device (“server”) 102 coupled across a communications network 104 to a client computing device (“client”) 106. Network 104 may include any combination of a local area network (LAN) and a general wide area network (WAN) communication environments, such as those which are commonplace in offices, enterprise-wide computer networks, intranets, and the Internet. Server and client computing devices 102 and 106 represent any type of computing device such as a personal computer, a laptop, a server, handheld or mobile computing device (e.g., a cellular phone, personal digital assistant), and/or so on.

Server 102 includes program modules 108 and program data 110. Program modules 108 include, for example, editor 112. Editor 112 is configured to allow a user to create generic installation modifier package 114. In this implementation, editor 112 implements a markup language such as XML to generate generic installation modifier package 114. Generic installation modifier package 114 is generic (not proprietary) because it is not specifically designed to target a proprietary data format of a particular installer or runtime environment. Rather, content of generic installation modifier package 114 is interpreted within any arbitrary runtime environment for conversion to any arbitrary target data format used by an installer executing within that particular runtime environment or a different runtime environment. (Such generic installation modifier package 114 conversion for a baseline application installation modification is described in greater detail below in reference to a patch engine and an installer of client 106). This is in contrast to conventional installation packages, which are typically hardwired (i.e., unidirectional) in data format to conform to a particular operating environment and installer.

Besides basic identification and machine state tracking information, generic installation modifier package 114 specifies only information, components, and/or data resources that represent the difference(s) between a client 102 baseline application installation and a target modified representation of the baseline application installation. For purposes of illustration, such a baseline application installation is shown as one or more respective portions of “other applications” 116 on client 106. In this implementation, the differences indicate, for example, state tracking information, and/or modifications to the existing baseline installation, locations of files. File include resource collections, for example, such as supporting file(s) (e.g., “inf” files, executable(s), registry changes, and/or so on) and a payload of file(s) and/or configuration data (e.g., DLLs, executables, scripts, configuration data, and/or so on). Collectively, these differences are referred to as package contents. The package contents are directly specified by user interaction (e.g., keyboard, voice recognition, and/or so on) with editor 112, and not by generating an installer image (e.g., a patch file such as an MSP file) via programmatic comparison between a baseline installation package installed on the client computing device 102 and a target updated installation package for communicating to the client computing device 102.

Table 1 shows an exemplary tag set for a generic installation modifier package 114.

TABLE 1
AN EXEMPLARY GENERIC INSTALLATION PACKAGE

```
<Patch>
    <State Tracking Information>
    ...
    </State Tracking Information>
    <MetaData>
    ...
    </MetaData>
    <Application Installation Differences Information>
    ...
    </Application Installation Differences Information>
</Patch>
```

As shown in TABLE 1, generic installation modifier package 114 includes customizable tags, enabling a user to define, transmit, validate, and interpret data for modifying a baseline application installation. In this implementation, the tag names are arbitrary and represent data for converting contents of the generic installation modifier package 114 into a patch file. Such a patch file is described below with respect to translated patch 118. For example, the tag “patch” denotes the beginning and end of the contents for generic installation modifier package 114. The tag “state tracking information” denotes a section for supplying installation and target device (e.g., client 102) state information such as versioning, and/or other information.

The “MetaData” tag provides a data definition area to specify data that is transparent to the installer application that will parse generic installation modifier package 114. In one implementation, for example, an application (see, “other applications” 116) other than an installer application (e.g., installer 120) utilizes the transparent data to present user interface information indicating modifications made, or to be made, to a baseline application installation. (As described below, such modifications are detailed in the data area denoted by the “Application Installation Differences Information” tag pair). In another implementation, the transparent data is used to describe feature layout for a different patch file. In another implementation, the transparent data describes configuration information for an application in combination with, or independent of, components/resources for an installation modification. As can be appreciated, purpose and data format of such transparent data is arbitrary and a function of the particular implementation.

TABLE 2 shows an exemplary implementation of the MetaData tag pair in generic installation modifier package 114.

TABLE 2
EXEMPLARY INSTALLER TRANSPARENT METADATA

```
<Metadata>
    <Feature Name=“ProductFiles” InstallLevel=“90”>
        <Option Id=“OfficeCore”>
            <Option Id=“WordCore”>
                <Option Id=“WordHelp”/>
            </Option>
            <Option Id=“ExcelCore”/>
            <Option Id=“PowerPointCore”/>
            <Option Id=“OutlookCore”/>
            <Option Id=“SharedCore”/>
        </Option>
    </Feature>
</Metadata>
```

In this exemplary implementation, the metadata is provided for an application other than installer 120 for compressing to a path and application to customize a product.

An “Application Installation Differences Information” tag pair, of which there may be one or more, provides a data area to identify a particular application, and indicate the modifications to the particular application and/or associated resources, as well as the location(s) of corresponding files, data, etc. In this implementation, this data area includes table, row, and column specifications that map to corresponding ones of table, row, and column identifiers in an original patch file used to install the baseline application that is being targeted for modification. As indicated above, and although the generic installation modifier package 114 shows a single “Application Installation Differences Information” tag pair, generic installation modifier package 114 can have any number of such tag pairs—one tag pair for each application of a baseline application installation that is being modified in some manner.

Table 3 shows another exemplary implementation of generic installation modifier package 114.

TABLE 3
AN EXEMPLARY GENERIC INSTALLATION PACKAGE

```
<Patch Name=“mso” PatchCode=“{09E3FD7F-1366-4EEE-ACF2-00DAE1FCD670}”
PatchSequence=“6204” FamilyName=“pro11_CHT”>
    <SummaryInfo or State Tracking Information>
        <Property PID=“2” Value=“Patch;pro11_CHT;6204;Comment”/>
        <Property PID=“3” Value=“KB000000”/>
        <Property PID=“6” Value=“11.0.5614.0 11.0.5614.0”/>
        <Property PID=“7” Value=“{90110409-6000-11D3-8CFE-0150048383C9}”/>
        <Property PID=“8” Value=“:pro11_ENG;:#pro11_ENG”/>
        <Property PID=“9” Value=“{09E3FD7F-1366-4EEE-ACF2-00DAE1FCD670}”/>
        <Property PID=“15” Value=“2”/>
    </SummaryInfo or State Tracking Information >
    <Metadata>
        <Feature Name=“ProductFiles” InstallLevel=“90”>
            <Option Id=“OfficeCore”>
                <Option Id=“WordCore”>
                    <Option Id=“WordHelp”/>
                </Option>
                <Option Id=“ExcelCore”/>
                <Option Id=“PowerPointCore”/>
                <Option Id=“OutlookCore”/>
                <Option Id=“SharedCore”/>
            </Option>
        </Feature>
    </Metadata>
    <Application Installation Differences Informations>
        <Application Installation Differences Information> // Per Application
        <MSI ProductCode=“{90110409-6000-11D3-8CFE-0150048383C9}”>
            <MST Name=“pro11_ENG”>
                <TableImports/>
                <Tables>
                    <Table Name=“File”>
                        <Row Type=“Update”>
                        <Column Id=“0” Name=“File” Key=“1” Value=“MSO.DLL”/>
                        <Column Id=“3” Name=“FileSize” Value=“12180160”/>
                        <Column Id=“4” Name=“Version” Value=“11.0.6204.0”/>
                        <Column Id=“7” Name=“Sequence” Value=“2000” />
                    </Row>
                </Table>
                <Table Name=“Property”>
                    <Row Type=“Insert”>
                        <Column Id=“0” Name=“Property” Key=“1” Value=“_09E3FD7F-1366-
4EEE-ACF2-00DAE1FCD670_”/>
                        <Column Id=“1” Name=“Value” Value=“Patch;mso;6204;Comment”/>
                    </Row>
                </Table>
                <Table Name=“CustomAction”>
                    <Row Type=“Delete”>
                        <Column Id=“0” Name=“Action” Key=“1”
Value=“SetREINSTALL_mso”/>
                    </Row>
                    <Row Type=“Delete”>
                        <Column Id=“0” Name=“Action” Key=“1”
Value=“SetREINSTALLMODE_mso”/>
                    </Row>
                    <Row Type=“Delete”/>
                        <Column Id=“0” Name=“Action” Key=“1” Value=“SetPreselected_mso”/>
                    </Row>
                </Table>
                <Table Name=“InstallUISequence”>
                    <Row Type=“Insert”>
                        <Column Id=“0” Name=“Action” Key=“1”
Value=“SetREINSTALL_mso”/>
                        <Column Id=“1” Name=“Condition” Value=“Installed AND PATCH AND
PATCH &gt;&lt; pro11tarupg_mso AND (NOT REMOVE ˜= &quot;ALL&quot;) AND REINSTALL =
&quot;&quot;”/>
                        <Column Id=“2” Name=“Sequence” Value=“101”/>
                    </Row>
                    <Row Type=“Insert”>
                        <Column Id=“0” Name=“Action” Key=“1”
Value=“SetREINSTALLMODE_mso”/>
                        <Column Id=“1” Name=“Condition” Value=“Installed AND PATCH AND
PATCH &gt;&lt; pro11tarupg_mso AND (NOT REMOVE ˜= &quot;ALL&quot;)”/>
                        <Column Id=“2” Name=“Sequence” Value=“102”/>
                    </Row>
                    <Row Type=“Insert”>
                        <Column Id=“0” Name=“Action” Key=“1” Value=“SetPreselected_mso”/>
                        <Column Id=“1” Name=“Condition” Value=“Installed AND PATCH AND
PATCH &gt;&lt; pro11tarupg_mso AND (NOT REMOVE ˜= &quot;ALL&quot;)”/>
                        <Column Id=“2” Name=“Sequence” Value=“103”/>
                    </Row>
                    <Row Type=“Delete”/>
                        <Column Id=“0” Name=“Action” Key=“1” Value=“SetREINSTALL”/>
                    </Row>
                    <Row Type=“Delete”>
                        <Column Id=“0” Name=“Action” Key=“1”
Value=“SetREINSTALLMODE”/>
                    </Row>
                    <Row Type=“Delete”>
                        <Column Id=“0” Name=“Action” Key=“1” Value=“SetPreselected”/>
                    </Row>
                </Table>
                <Table Name=“InstallExecuteSequence”>
                    <Row Type=“Insert”>
                        <Column Id=“0” Name=“Action” Key=“1”
Value=“SetREINSTALL_mso”/>
                        <Column Id=“1” Name=“Condition” Value=“Installed AND PATCH AND
PATCH &gt;&lt; pro11tarupg_mso AND (NOT REMOVE ˜= &quot;ALL&quot;) AND REINSTALL =
&quot;&quot;”/>
                        <Column Id=“2” Name=“Sequence” Value=“102”/>
                    </Row>
                    <Row Type=“Insert”>
                        <Column Id=“0” Name=“Action” Key=“1”
Value=“SetREINSTALLMODE_mso”/>
                        <Column Id=“1” Name=“Condition” Value=“Installed AND PATCH AND
PATCH &gt;&lt; pro11tarupg_mso AND (NOT REMOVE ˜= &quot;ALL&quot;)”/>
                        <Column Id=“2” Name=“Sequence” Value=“103”/>
                    </Row>
                    <Row Type=“Insert”>
                        <Column Id=“0” Name=“Action” Key=“1” Value=“SetPreselected_mso”/>
                        <Column Id=“1” Name=“Condition” Value=“Installed AND PATCH AND
PATCH &gt;&lt; pro11tarupg_mso AND (NOT REMOVE ˜= &quot;ALL&quot;)”/>
                        <Column Id=“2” Name=“Sequence” Value=“104”/>
                    </Row>
                    <Row Type=“Delete”/>
                        <Column Id=“0” Name=“Action” Key=“1” Value=“SetREINSTALL”/>
                    </Row>
                    <Row Type=“Delete”/>
                        <Column Id=“0” Name=“Action” Key=“1”
Value=“SetREINSTALLMODE”/>
                    </Row>
                    <Row Type=“Delete”/>
                        <Column Id=“0” Name=“Action” Key=“1” Value=“SetPreselected”/>
                    </Row>
                </Table>
            </Tables>
            <SummaryInfo>
                <Property PID=“2” Value=“Installation Database”/>
                <Property PID=“3” Value=“Microsoft Office Professional Edition 2003”/>
                <Property PID=“4” Value=“Microsoft Corporation”/>
                <Property PID=“5” Value=“Installer,MSI,Database,Release”/>
                <Property PID=“6” Value=“This Installer database contains the logic and data
required to install Microsoft Office Professional Edition 2003.”/>
                <Property PID=“7” Value=“Intel;1033”/>
                <Property PID=“8” Value=“Intel;1033”/>
                <Property PID=“9” Value=“{90110409-6000-11D3-8CFE-
0150048383C9}11.0.5614.0;{90110409-6000-11D3-8CFE-0150048383C9}11.0.5614.0;{00110000-6000-
11D3-8CFE-0050048383C9}”/>
                <Property PID=“12” Value=“8/9/2003 13:10:22.0”/>
                <Property PID=“14” Value=“100”/>
                <Property PID=“16” Value=“0x927001F”/>
                <Property PID=“18” Value=“Microsoft Setup Compiler”/>
            </SummaryInfo>
        </MST>
        <MST Name=“#pro11_ENG”>
                <TableImports>
                    <Table Name=“PatchPackage”>
                        <Column Name=“PatchId” Type=“s38” Key=“1”/>
                        <Column Name=“Media_” Type=“i2”/>
                    </Table>
                </TableImports>
                <Tables>
                    <Table Name=“PatchPackage”>
                        <Row Type=“Insert”>
                            <Column Id=“0” Name=“PatchId” Key=“1” Value=“{09E3FD7F-1366-
4EEE-ACF2-00DAE1FCD670}”/>
                            <Column Id=“1” Name=“Media_” Value=“4000”/>
                        </Row>
                    </Table>
                </Tables>
                <SummaryInfo>
                    <Property PID=“2” Value=“Installation Database”/>
                    <Property PID=“3” Value=“Microsoft Office Professional Edition 2003”/>
                    <Property PID=“4” Value=“Microsoft Corporation”/>
                    <Property PID=“5” Value=“Installer,MSI,Database,Release”/>
                    <Property PID=“6” Value=“This Installer database contains the logic and data
required to install Microsoft Office Professional Edition 2003.”/>
                    <Property PID=“7” Value=“Intel;1033”/>
                    <Property PID=“8” Value=“Intel;1033”/>
                    <Property PID=“9” Value=“{90110409-6000-11D3-8CFE-
0150048383C9}11.0.5614.0;{90110409-6000-11D3-8CFE-0150048383C9}11.0.5614.0;{00110000-6000-
11D3-8CFE-0050048383C9}”/>
                    <Property PID=“12” Value=“8/9/2003 13:10:22.0”/>
                    <Property PID=“14” Value=“100”/>
                    <Property PID=“16” Value=“0x927001F”/>
                    <Property PID=“18” Value=“Microsoft Setup Compiler”/>
                </SummaryInfo>
            </MST>
        </Application Installation Differences Information>
    </Application Installation Differences Informations>
    <Cabinet Name=“PCW_CAB_Patch”/>
        <File Name=“MSO.DLL” Type=“Patch” Location=“%SETUPEXE%\patch\test\data\test.dll”/>
    </Cabinet>
</Patch>
```

In this implementation, server 102 communicates the generic installation modifier package 114 in message 122 to client 106. In another implementation, client 106 receives the generic installation modifier package 114 in some other manner (e.g., via CD-ROM, etc.). Responsive to receiving generic installation modifier package 114, client 106—and more particularly patch engine 124, parses the generic installation modifier package 114 to covert its content into a data format that is compatible data format requirements of installer application 120. For purposes of discussion and exemplary illustration, converted content of generic installation modifier package 114 is shown as translated patch 118. The data format used by installer 120, and therefore the data format of translated patch 118, is arbitrary, and typically a function of the particular architecture of the target installer 120 and/or the particular operating system used to provide a runtime environment on client 106.

In one implementation, installer 120 is a WINDOWS installer and the target data format is a MSP file data format for modification of an existing application installation, wherein the existing application installation was described by a conventional installation package in the MSI data format.

An Exemplary Procedure

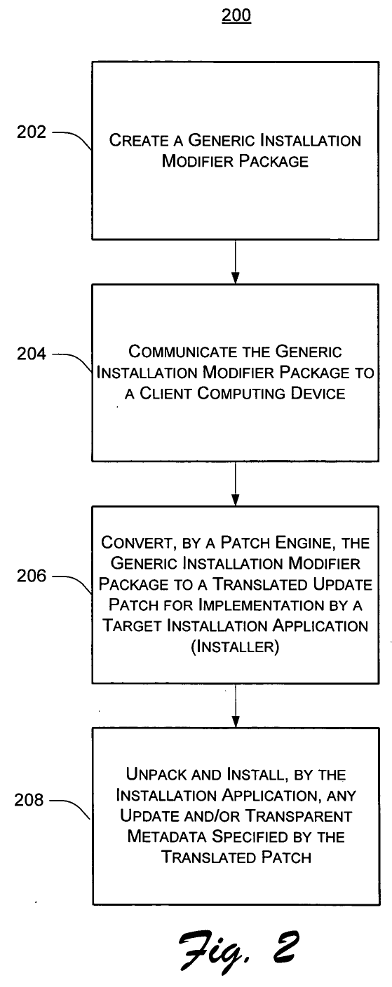

FIG. 2 shows an exemplary procedure 200 for modifying application installations. For purposes of discussion, the operations of this procedure are described with respect to aspects of FIG. 1. The left-most digit of a component reference number identifies the particular figure in which the component first appears. At block 202, an editor 110 (FIG. 1) generates a generic installation modifier package 114. At block 204, the generic installation modifier package 114 is communicated to a client computing device 106. At block 206, patch engine 124 parses and converts/transforms the generic installation modifier package 114 to translated patch 118 (e.g., in a WINDOWS installer patch data format). In this implementation, such parsing is performed via a markup language parser (e.g., an XML parser). Translated patch 118 is in a data format targeted for input to a particular installation program such as installer 120. In one implementation, the translated patch 118 includes product customization information (“MetaData”) that is transparent to installer 120. At block 208, installer 120 implements or installs the patch to upgrade, configure, or otherwise provide metadata to an existing installation. For purposes of illustration, an existing installation is shown as “other application(s) 116.

An Exemplary Operating Environment

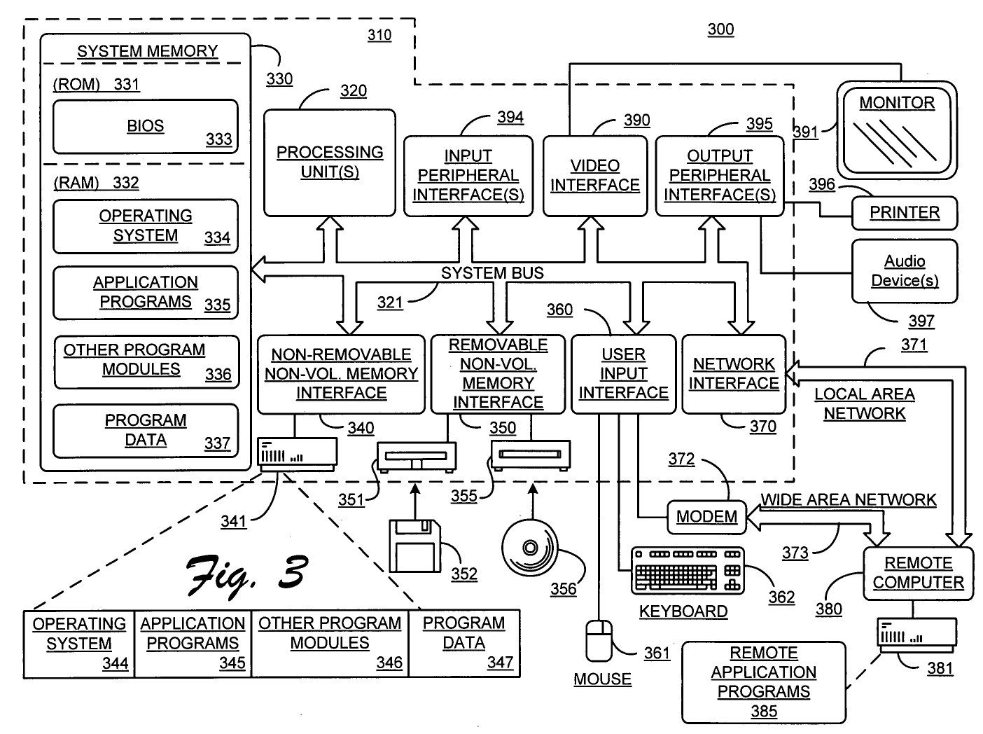

FIG. 3 shows an example of a suitable computing environment in which systems and methods for modifying application installations may be fully or partially implemented. Exemplary computing environment 300 is only one example of a suitable computing environment for the exemplary system of FIG. 1 and exemplary operations of FIG. 2, and is not intended to suggest any limitation as to the scope of use or functionality of systems and methods the described herein. Neither should computing environment 300 be interpreted as having any dependency or requirement relating to any one or combination of components illustrated in computing environment 300.

The methods and systems described herein are operational with numerous other general purpose or special purpose computing system, environments or configurations. Examples of well-known computing systems, environments, and/or configurations that may be suitable for use include, but are not limited to, mobile computing devices such as mobile phones and personal digital assistants, personal computers, server computers, multiprocessor systems, microprocessor-based systems, network PCs, minicomputers, mainframe computers, distributed computing environments that include any of the above systems or devices, and so on. The invention is practiced in a distributed computing environment where tasks are performed by remote processing devices that are linked through a communications network. In a distributed computing environment, program modules may be located in both local and remote memory storage devices.

With reference to FIG. 3, an exemplary system for modifying application installations includes a general purpose computing device in the form of a computer 310 implementing, for example, either of server 102 or client 106 of FIG. 1. Components of computer 310 may include, but are not limited to, processing unit(s) 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example and not limitation, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

A computer 310 typically includes a variety of computer-readable media. Computer-readable media can be any available media that can be accessed by computer 310 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 310.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example and not limitation, communication media includes wired media such as a wired network or a direct-wired connection, and wireless media such as acoustic, RF, infrared and other wireless media. Combinations of the any of the above should also be included within the scope of computer-readable media.

System memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example and not limitation, FIG. 3 illustrates operating system 334, application programs 335, other program modules 336, and program data 337.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 3, provide storage of computer-readable instructions, data structures, program modules and other data for the computer 310. In FIG. 3, for example, hard disk drive 341 is illustrated as storing operating system 344, application programs 345, other program modules 346, and program data 348. Note that these components can either be the same as or different from operating system 334, application programs 335, other program modules 336, and program data 338. Application programs 335 includes, for example program module(s) 112 and/or 118 of FIG. 1. Program data 338 includes, for example, program data 114 and/or 120 of FIG. 1. Operating system 344, application programs 345, other program modules 346, and program data 347 are given different numbers here to illustrate that they are at least different copies.

A user may enter commands and information into the computer 310 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus 321, but may be connected by other interface and bus structures, such as a parallel port, game port, or a universal serial bus (USB).

A monitor 391 or other type of display device is also connected to the system bus 321 via an interface, such as a video interface 390. In addition to the monitor, computers may also include other peripheral output devices such as printer 396 and audio devices 397, which may be connected through an output peripheral interface 395.

The computer 310 operates in a networked environment using logical connections to one or more remote computers, such as a remote computer 380. In one implementation, computer 310 represents server computing device 102 and remote computer 380 represents client computing device 106 of FIG. 1, or vice versa. The remote computer 380 may be a mobile computing device, a personal computer, a server, a router, a network PC, a peer device or other common network node, and as a function of its particular implementation, may include many or all of the elements described above relative to the client computing device 106, although only a memory storage device 381 has been illustrated in FIG. 3. The logical connections depicted in FIG. 3 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example and not limitation, FIG. 3 illustrates remote application programs 385 as residing on memory device 381. The network connections shown are exemplary and other means of establishing a communications link between the computers may be used.

### CONCLUSION

Although the systems and methods for modifying application installations have been described in language specific to structural features and/or methodological operations or actions, it is understood that the implementations defined in the appended claims are not necessarily limited to the specific features or actions described. For example, although operations to create a generic installation modifier package 114 (FIG. 1) have been shown and described as being implemented on a computing device separate from the computing device used to convert the generic installation modifier package 114 into translated patch 118 for subsequent modification of a baseline application installation, these operations can be performed on a single computing device. Accordingly, the specific features and operations are disclosed as exemplary forms of implementing the claimed subject matter.

1. A method comprising:
creating a generic installation modifier package, the generic installation modifier package specifying differences between a target modified application installation and an already installed baseline application installation, the generic installation modifier package not specifying information that is extraneous to modification of the baseline application installation unless the information is designated as being transparent to an installer application; and
communicating the generic installation modifier package to a patch engine, the patch engine being configured to generate a patch from the generic installation modifier package, the patch for modifying the already installed baseline application installation.

2. A method as recited in claim 1, further comprising converting, by the patch engine, content of the generic installation modifier package to a different data format, the different data format being a data format utilized by the installer application.

3. A method as recited in claim 1, wherein creating further comprises creating the generic installation modifier package in a markup language.

4. A method as recited in claim 1, wherein creating, the generic installation modifier package is created independent of programmatically generating or comparing an installation package representing the baseline application installation to any other installation package.

5. A method as recited in claim 1, wherein the method further comprises:
parsing the generic installation modifier package to generate a translated patch, the translated patch being in a data format associated with a particular installer and/or operating environment; and
wherein the translated patch is generated independent of any programmatic comparison of information in an installation package that comprises information extraneous to modification of the already installed baseline application installation.

6. A method as recited in claim 1, wherein the method further comprises:
parsing the generic installation modifier package to generate a translated patch, the translated patch being in a data format associated with a particular installation application or operating system; and
implementing, by the installer application, the translated patch to modify the baseline application installation.

7. A method comprising:
specifying, at a first computing device, differences between a target modified application installation and an already installed baseline application installation, the already installed baseline application being installed at a second computing device; and
converting, at the second computing device, the differences into a patch with a data format different than the markup language, the data format being specific to an installer application or operating environment, the installer application for implementing the patch to modify the already installed baseline application installation.

8. A method as recited in claim 7, wherein specifying further comprises specifying the differences in a markup language.

9. A method as recited in claim 7, wherein the differences are specified with state tracking information and application installation modifications.

10. A method as recited in claim 7, wherein the differences are specified in a generic installation modifier package.

11. A method as recited in claim 7, wherein the differences are specified in a generic installation modifier package, and wherein specifying further comprises inserting metadata into the generic installation modifier package, the metadata being designated to be transparent to an installer application, the installer application for modifying the already installed baseline application installation based on the differences.

12. A method as recited in claim 7, wherein the differences are specified in a generic installation modifier package, the generic installation modifier package not specifying information that is extraneous to modification of the already installed baseline application installation unless the information is specifically designated to be transparent to an installer application, the installer application for modifying the already installed baseline application installation as a function of the differences.

13. A method as recited in claim 7, wherein the differences are specified independent of programmatically generating or comparing an installation package representing the baseline application installation to any other installation package.

14. A method as recited in claim 7, wherein the patch is generated independent of any programmatic comparison of information in an installation package that comprises information extraneous to modification of the already installed baseline application installation.

15. A method as recited in claim 7, and further comprising implementing, by the installer application, the patch to modify the already installed baseline application installation.

16. A method comprising:
editing, at a first computing device, a generic installation modifier package to insert metadata into the generic installation modifier package, the metadata being transparent to an installer application for installing a patch generated from the generic installation modifier package;
generating the patch at a second computing device from content of the generic installation modifier package;
modifying an already installed baseline application installation as a function of the patch; and
utilizing the metadata, by an application other than the installer application, to perform an operation, present information, or configure an application.

17. A method as recited in claim 16, wherein the generic installation modifier package is specified in a markup language.

18. A method as recited in claim 16, wherein the generic installation modifier package specifies state tracking information and at least one application installation modification.

19. A method as recited in claim 16, wherein the patch is in a data format that is different than a data format associated with the generic installation modifier package, the patch being in a data format compatible with the installer application.

20. A method as recited in claim 16, wherein the patch is generated independent of any programmatic comparison of information in an installation package that comprises information extraneous to modification of the already installed baseline application installation.
